(19) United States
(12) Patent Application Publication
(10) Pub. No.: US 2026/0318263 A1
(43) Pub. Date: Oct. 15, 2026

(54) MICRO STIRLING ENGINE

(71) Applicant: The Charles Stark Draper Laboratory, Inc., Cambridge, MA (US)

(72) Inventors: Kasia Oleske, Cambridge, MA (US); James Bickford, Cambridge, MA (US); Ryann Hee, Cambridge, MA (US)

(21) Appl. No.: 19/474,010

(22) PCT Filed: Apr. 11, 2024
(86) PCT No.: PCT/US2024/024072

§ 371 Date: Oct. 9, 2025

Related U.S. Application Data
(60) Provisional application No. 63/495,359, filed on Apr. 11, 2023.

(51) Int. Cl. F02G 1/044; F02G 1/045; F02G 1/057

(52) U.S. Cl. CPC F02G 1/044; F02G 1/045; F02G 1/057; F02G 2250/31

(57) ABSTRACT

A micro heat engine for utilizing temperature differential for high efficiency heat conversion, may include a housing have a hot side and a cold side, a plurality of pistons arranged within the housing, each extending from the hot side to the cold side; and a plurality of regenerators, each configured to be arranged between two adjacent pistons and configured to store heat generated as working gas moves within the adjacent pistons.

### CROSS-REFERENCE TO RELATED APPLICATIONS

This application claims the benefit of U.S. provisional application Ser. No. 63/495,359 filed Apr. 11, 2023, the disclosure of which is hereby incorporated in its entirety by reference herein.

### TECHNICAL FIELD

Aspects of the disclosure generally relate to systems and methods for micro Stirling engines.

### BRIEF DESCRIPTION OF THE DRAWINGS

The embodiments of the present disclosure are pointed out with particularity in the appended claims. However, other features of the various embodiments will become more apparent and will be best understood by referring to the following detailed description in conjunction with the accompanying drawings in which:

FIG. 1 illustrates a cross-sectional view of an example thermoelectric converter.

FIG. 2 illustrates a perspective view of an example double-acting Stirling engine.

FIG. 3 illustrates a top view of the example double-acting Stirling engine of FIG. 2.

FIG. 4 illustrates a side view of the example double-acting Stirling engine of FIG. 2.

FIG. 5 illustrates another cross-sectional view of the example double-acting Stirling engine of FIG. 2 illustrating example dimensions.

FIG. 6 illustrates a cross-sectional view of the example double-acting Stirling engine of FIG. 2 illustrating a sinusoidal motion of the pistons in series with one another.

FIG. 7 illustrates a chart of an example glass housing area vs. efficiency.

FIG. 8 illustrates a chart of an example heat flow vs. efficiency.

FIG. 9 illustrates a chart of an example damping vs. efficiency.

FIG. 10 illustrates a chart of an example damping vs. heat energy.

FIG. 11 illustrates a chart of an example spring constant vs. efficiency.

FIG. 12 illustrates a chart of an example spring constant vs. heat energy.

FIG. 13 illustrates a chart of an example gas pressure vs. efficiency.

FIG. 14 illustrates a chart of an example gas pressure vs. heat energy.

FIG. 15 illustrates a chart of piston motion over time at a gas pressure of greater than or equal to 8.0 atm.

FIG. 16A illustrates a chart of piston motion over time for piston deviation.

FIG. 16B illustrates a chart of piston motion over time for piston stability.

FIG. 17 illustrates an example 2 piston model of a Stirling engine.

FIG. 18 illustrates example values for various housing properties.

FIG. 19 illustrates an example chart of efficiency vs. hot side temperature.

FIG. 20 illustrates an example chart of the efficiency based on the damping vs. spring constant.

FIG. 21 illustrates an example chart of the efficiency based on damping vs. piston mass.

FIG. 22 illustrates another example chart of the efficiency based on the damping vs. spring constant.

FIG. 23 illustrates another example chart of the efficiency based on damping vs. piston mass.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Technologies continue to advance and there is a desire to increase available energy. Oftentimes, self-contained power systems are needed, but the energy demands cannot be met by batteries alone. Specifically, there is a desire have an energy source that is both small and powerful. For example, space probes, portable power, and other high reliability systems have a need for power in remote, harsh environments that require unique materials development to meet growing power and thermal management requirements while still maintaining small form factors. Today there are no micro power systems that have efficiencies greater than ~2% which meet all mechanical, thermal, and system requirements for space probes and other small form factor power needs. In addition, this could be used for microelectronics cooling and waste heat applications, as well as other applications.

In the example of energy sources for the space industry, thermoelectric power sources, such as thermoelectric generators (TEGs), and photovoltaics, are typically used. However, as the size of these components decrease, so does the power that they provide. Currently, small scale (mW) TEGs have an operational efficiency of 2%.

Other thermoelectric technologies, such as Stirling engines, are known to achieve high efficiency (30-40%). Stirling engines are heat engines that operate by cyclic compression and expansion of air or other gasses between different temperatures, resulting in heat conversion. Stirling engines use an input heat in a closed cycle regenerative heat engine to convert heat energy to mechanical work. At larger power outputs, Stirling engines are highly efficient compared to thermoelectric generators, but may still suffer parasitic losses that occur on such a small scale.

Disclosed herein is a Stirling engine fabricated from a set of MEMS materials capable of miniaturization for applications in small-scale (mm), high efficiency power generation that mitigates losses based on optimized parameters. In one example, the engine is a 2 W Stirling engine, but other examples, specifically in the range from 1 Wth to 200 Wth may be realized. This engine has the ability to operate with low quality or relatively low temperature heat sources, enabling waste heat recover where other power generators would not apply or be unable to operate. The engine may thus be used as a portable power source, and may use various fuels, such as butane. The engine may also be operated for heat production, cooling, etc. Further, due to the miniaturization of the engine, additional power generation devices may be used. For example, the power generation may include piezo generators, capacitive coupling, and embedded magnetic and coil pairs.

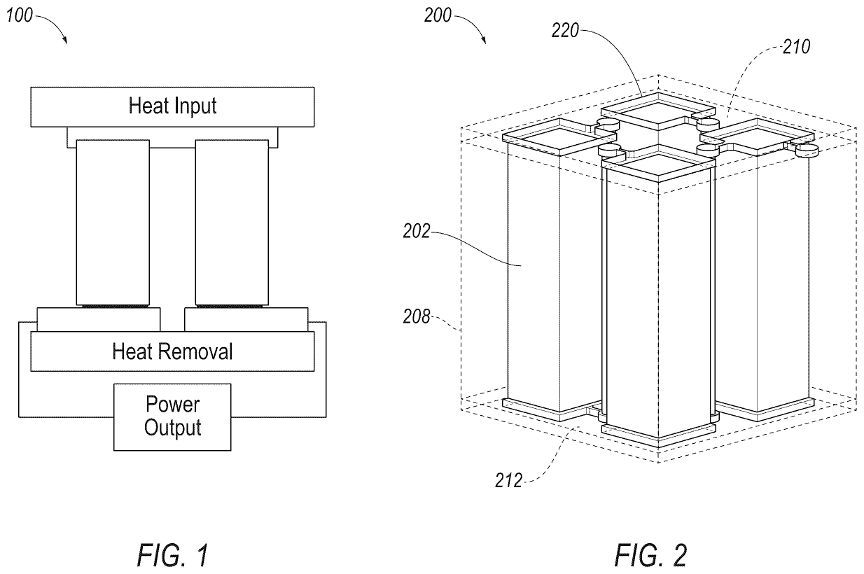

FIG. 1 illustrates a cross-sectional view of an example thermoelectric converter 100.

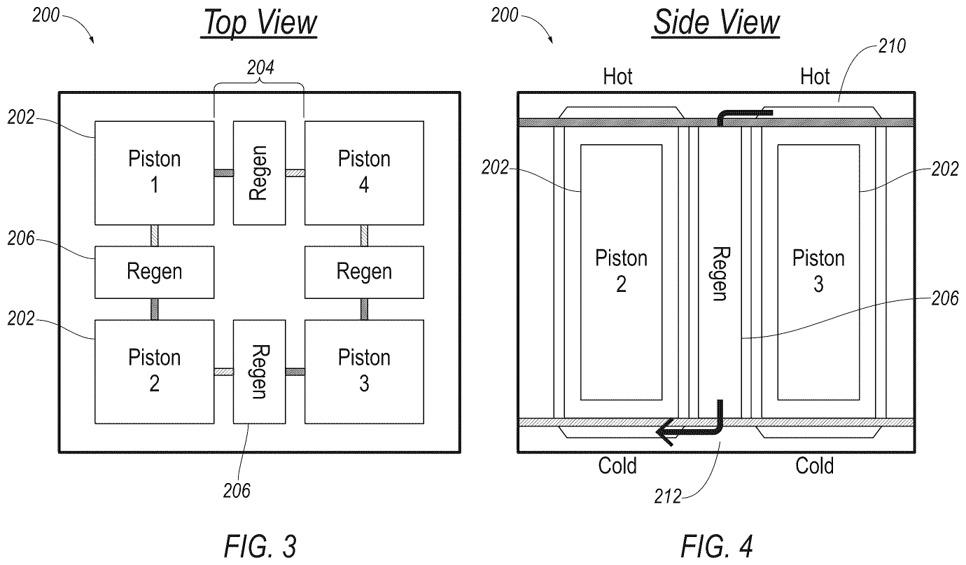

FIG. 2 illustrates a perspective view of an example double-acting Stirling engine 200. FIG. 3 illustrates a top view of the example double-acting Stirling engine 200 of FIG. 2, while FIG. 4 illustrates a side view of the engine of FIG. 2.

Referring to FIGS. 2-4, the double-acting Stirling engine 200 may include four pistons 202 and regenerators 206. Notably, the engine 200 may receive any even number of pistons. The pistons 202 are illustrated as being generally cubical and spaced equidistant from each other in a two-by-two arrangement in order to form a collective cubical shape. The pistons are connected to each other via rods or tubes and may include various valves, seals, etc. The pistons 202 and regenerators 206 are arranged in a housing 208. The housing 208 is hermetically sealed to enclose fluid, typically a gas, therein. The housing 208 includes a hot plate 210 at one end of the pistons 202 and a cold plate 212 at the opposite end of the pistons 202. As Stirling engines gain efficiency based on temperature differential, the greater the distance between the hot and cold sides, the greater the efficiency. The hot side or hot plate 212 may start at a temperature of 500K. The cold side temperature may be approximately 300K. The temperatures are examples and other temperatures may be appreciated.

The pistons 202 may be hollow pistons and may have an internal vacuum with low emissivity surfaces, which aid to mitigate thermal losses. The pistons 202 may be housed in a cubical housing and have a piston rod attached to a spring. Although not shown, the pistons may be cylindrical in another example. The spring may have a desired spring constant and be configured to apply resistance to pressure generated by the gas within the cylinder.

The pistons 202 may also be a combination of physical hard-stop pistons, as well as spring pistons. By utilizing double acting free pistons, the mechanics of the engine 200 are simplified and the lifetime is increased due at least in part to the lack of mechanical linkage. Further, this allows for a completely closed system which is easier to contain to heat. Using four pistons 202 specifically provides for easy phasing and balancing of the engine and allows for the pistons to be stabilized. In an example, the pistons 202 may be approximately 15 mm×22 mm×22 mm, but other dimensions may be appreciated. In some cases, one or more pistons of the pistons 202 may be about 8 mm by 2.5 mm by 2.5 mm. The cross-sectional area of the housing 208, may in relation, be approximately 2.204e⁻⁶ m², in one example.

The pistons 202 may form cavities 204 therebetween, the cavities 204 being configured to optimize space usage and minimis parasitic conductive losses through the frame. The cross-section and build of materials may also be formed to reduce flow losses and maximize heat transfer. Regenerators are attached to each piston and described in more detail herein. As illustrates, the housing 208 may have a square cross-section, creating a quadratic space to house the pistons 202 and create the cavities 206, which reduces parasitic conductance loss through the housing 208. The pistons 202 may be arranged in a two by two arrangement, forming the four symmetrical quadrants of the engine 208.

One of the regenerators 206 is arranged between each piston 202. The regenerators 206 may store heat as working gas moves from one side of the respective pistons 202 to the cold side of the respective pistons 202. Thus, these regenerators 206 store at least a portion of the heat that may otherwise be lost through the cavities 206. The cross-section of the regenerators 206 may be optimized to reduce flow losses and maximize heat transfer between the pistons 202. In one example, the regenerators 206 may include phase change material and may be horizontal instead of vertically arranged in the housing 208.

The regenerators 206 may be an internal heat exchanger and temporary heat storage place between the hot and cold spaces made of copper for example, which may allow the working fluid to pass through it first in one direction then the other, taking heat from the fluid in one direction, and returning it in the other. In one example, the regenerator 206 may change in size to optimize the heat transfer and efficiency between the hot side and cold side of the micro Stirling engine.

The regenerators 206 may be made of a material or materials capable of storing excess heat when the working fluid moves through the regenerator for the next cycle (cold side to the hot side), such that the heat is added back to the system to essentially preheat the working fluid. This improves the efficiency and power output of an engine by reducing the amount of heat wasted during engine cycles. In one example, the regenerators 206 may be formed of copper. Copper may act as an efficient heat exchanger and is also readily available.

TABLE 1
Example Material Property Values

| | | | Specific | Coefficient of |
|---|---|---|---|---|
| | | Thermal | Heat | Thermal |
| | Density | Conductivity | Capacity | Expansion |
| Material | (kg/m³) | (W/m-K) | (J/kg-K) | (m/m-K) |
| Glass | 2230 | 1.2 | 792 | 3.25 × 10⁻⁶ |
| Silicon | 2329 | 124 | 794 | 2.49 × 10⁻⁶ |
| Copper | 8930 | 385 | 385 | 16.4 × 10⁻⁶ |

The efficiency of the example engine 200 is higher than the traditional 2% efficiencies. The high temperature differentials allow for the cycle to be highly efficient. As most energy loss may be appreciated through the surface area of the housing, having a smaller housing, such as the housing 208, creates a higher efficiency engine over existing ones. Heat flow may be determined by Q=ΔT×A/L, where ΔT is the temperature difference, A is housing area, and L is housing height. While high temperatures increase Stirling cycle efficiency, such high temperatures may increase parasitic losses through the housing 208. To reduce the losses, in addition to having four pistons 202 and four regenerators 202 of minimal size, the temperatures may be set by a specific application based on the available heat source and local environment. At least one of the pistons 202 may enjoy a transient input force at startup. In one example, a traditional magnet or piezo film may be replaced with electrostatic for power generation and the start up actuation. This may reduce conducive loses through the piston magnet, as well as eliminate lossy films on flexure.

In addition to the above, the housing 208 may be made of a stiff material capable to maintain stable operating temperatures, have low thermal conductivity to avoid parasitic losses through the structure, but also be strong enough to support the load from the environment and internal pressures at operational temperatures. In one example, the housing 208 be formed, at least partially, of glass. Other elements may be added to the glass such as plastics, elastomers, metals and alloys, ceramics, foams, composites, silicon, Kapton Membrane film, air, etc, or any combination thereof. The glass allows for low thermal conductivity. In addition to the low thermal conductivity, as well as the decreased surface area of the smaller housing, the overall mechanical efficiency may be increased. Heat through the housing may be related by

$$Q = \frac{( A \cdot Th )}{L} . ,$$

where Th is the thermal conductivity.

Other materials, or combination of materials, may be contemplated for the housing, including polyimide, titanium, etc. Further, the housing 208 may be made of several different materials in different areas or different parts of the housing to most optimize the structural and thermal needs of the housing 208. The housing 208 is hermetically sealed to enclose the gas therein. Thus, the material used to form the housing 208 is in contact with the gas and thus heat may transfer from the gas to the housing material during operation. Again, in larger scales this is not typically an issue. However, such losses may be an issue for small scale Stirling engines. Thus, and as explained, glass may be selected as the material for the housing due to its low thermal conductivity (e.g., 1.2 Wmm-K), as well as its availability.

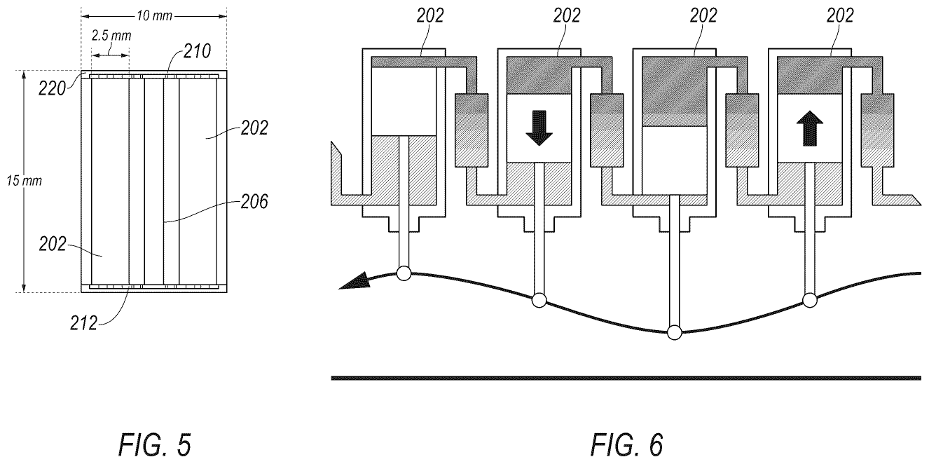

The housing 208 may be sealed off with a cap 220, as labeled in FIGS. 2 and 5. The cap 220 may further seal the housing 208 ensuring a hermetical seal therewith. The cap 220 is arranged between the hot and cold plates of the housing material and functions as an insulator to minimize heat transfer between the housing 208 and the cap 220. In one example, the cap 220 may be formed of silicon.

In addition to the materials discussed herein, other materials may also be considered in addition to copper, glass and silicon. For example, materials such as advanced polymers, nanocomposites, etc., may also offer additional or alternative advantages to the prior mentioned materials. These advantages may include the engine being lightweight and flexible, reducing the overall mass and volume of the engine. Other advantages may include enhanced thermal properties, or the properties may be tailored to specific environmental conditions.

FIG. 5 illustrates another cross-sectional view of an example engine 200 illustrating example dimensions. In this example, the dimensions are shown as the pistons each having a height of 15 mm and a width of 2.5 mm, while the total engine width is 10 mm. These dimensions are exemplary and other dimensions and ratios may be contemplated.

FIG. 6 illustrates a side view of the example engine illustrating a sinusoidal motion of the pistons 202 in series with one another. As explained, the pistons 202 are heated at the top and cooled at the bottom. In this example, working gas may be moved between adjacent pistons 202 via the interconnecting rods. The force exerted by the expanding gas on one side of a piston 202 is increased by contracting gas on the adjacent piston, increasing the pressure differential across the pistons 202. The movement of the pistons relative to the adjacent piston may be in a specific phase. The sinusoidal motion is created by such reciprocating movement of the adjacent pistons. The relative phasing may be enforced by electronic force feedback.

This process and feedback provides for thermodynamic stability to keep the piston phases aligned. The engine may include a power extractor which is configured to recover power from the structure. A typical approach is the magnet/coil pairing, but it could also leverage electrets or other capacitive coupling to convert the mechanical motion into electrical output. The advantage of the capacitive approach is that it removes the heavy magnet from the structure and allows the system to operate at higher temperatures. Additional approaches that may be available due to the miniaturization, such as piezo generators, coupling capacitor, etc., are also contemplated.

The mechanical structure will minimize thermal conductance while maximizing mechanical strength to support the structure and internal pressure. This involves material selection (strong, low conductivity materials, hybrid structures (e.g. piston sleeve with variable thickness with a different material than the main housing) and selective material removal to reduce thermal conductance in areas where material strength is less important. For example, topological optimization can be used to eliminate material where the strain is lowest due to the imposed loads (e.g pressure, environmental, etc.). Specific examples include hollowing out the inside of the piston and removing material from the center of the housing between all of the pistons, especially on the top and bottom where the bending stresses are lower.

The example engine alleviates some of the parasitic heat losses that existing solutions suffer from at such a scale and thus allows for the use of a Stirling Engine.

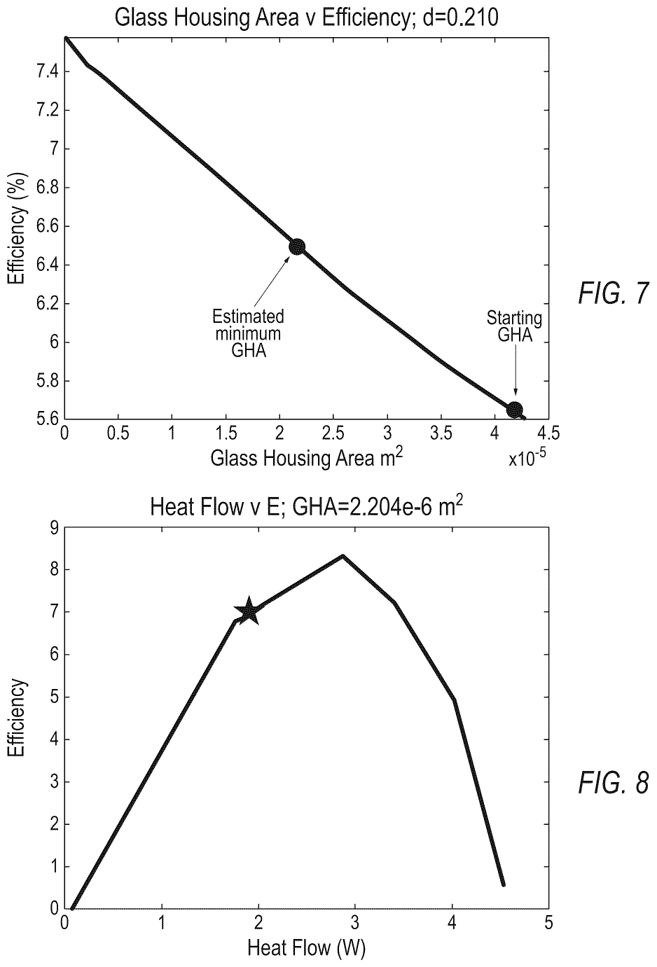

FIG. 7 illustrates a chart of an example glass housing area vs. efficiency. As illustrated, as the area increase, the efficiency decreases.

FIG. 8 illustrates a chart of an example heat flow vs. efficiency. As illustrated, a high efficiency (such as 8% as shown in FIG. 8) may be realized at a heat flow of approximately 3 W in this example. In these charts, the below parameters were realized:

TABLE 2
Example Engine Parameter Values

| Parameter | Value | Units |
|---|---|---|
| Housing area | 2.204 | mm² |
| Piston length | 14 | mm |
| Piston side | 2.5 | mm |
| Regen status | 0.65 | mm |
| k | 100 | |
| d | 0.0213 | |
| Efficiency | ~7.1% | |
| Power | 2.00 | W |
| Frequency | ~100 | Hz |
| Hot side temperature | 500 | K |
| Cold side temperature | 300 | K |

By reducing the housing area, the overall mechanical efficiency can be seen as increasing from 4% to 7%.

In addition to the housing size, various parameters may be established to create an efficient assembly, including but not limited to damping, spring constant, gas pressure, piston mass, regenerator size, gas type (He, N), etc.

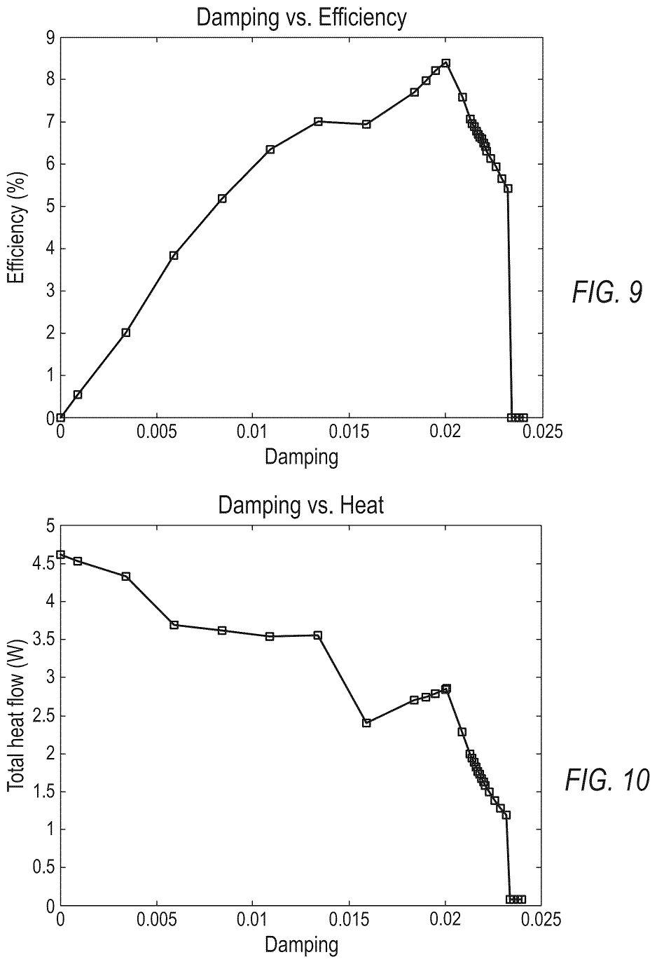

FIG. 9 illustrates a chart of an example damping vs. efficiency.

FIG. 10 illustrates a chart of an example damping vs. heat energy. In one example, a damping of 0.0213 may be achieved to balance efficiency with heat energy (W).

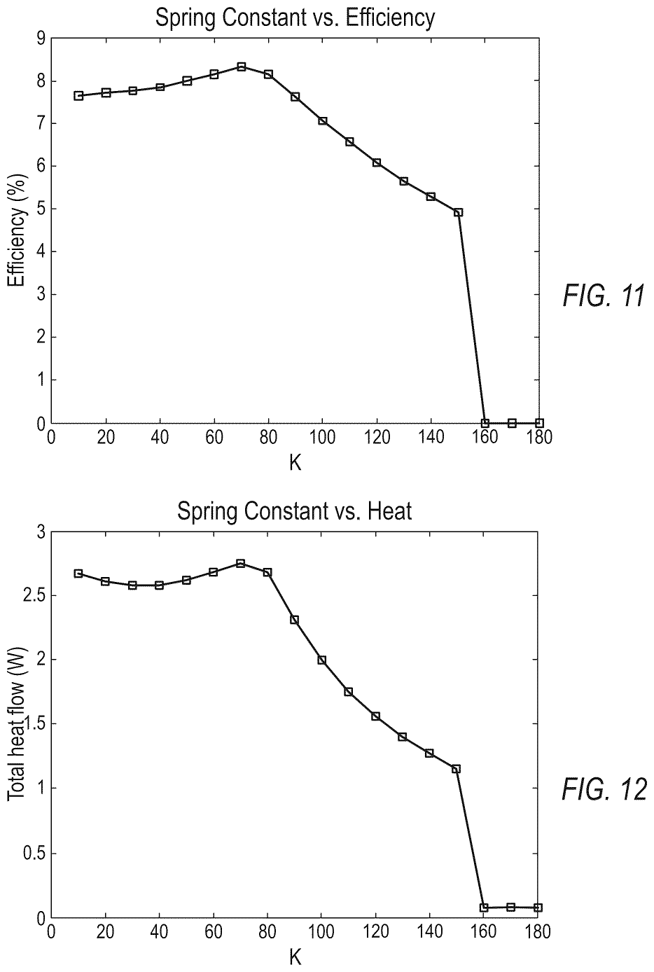

FIG. 11 illustrates a chart of an example spring constant vs. efficiency.

FIG. 12 illustrates a chart of an example spring constant vs. heat energy. Over constant damping and constant GHA, an example spring constant may be between 50-110 k. In a specific example, the spring constant may be 100.

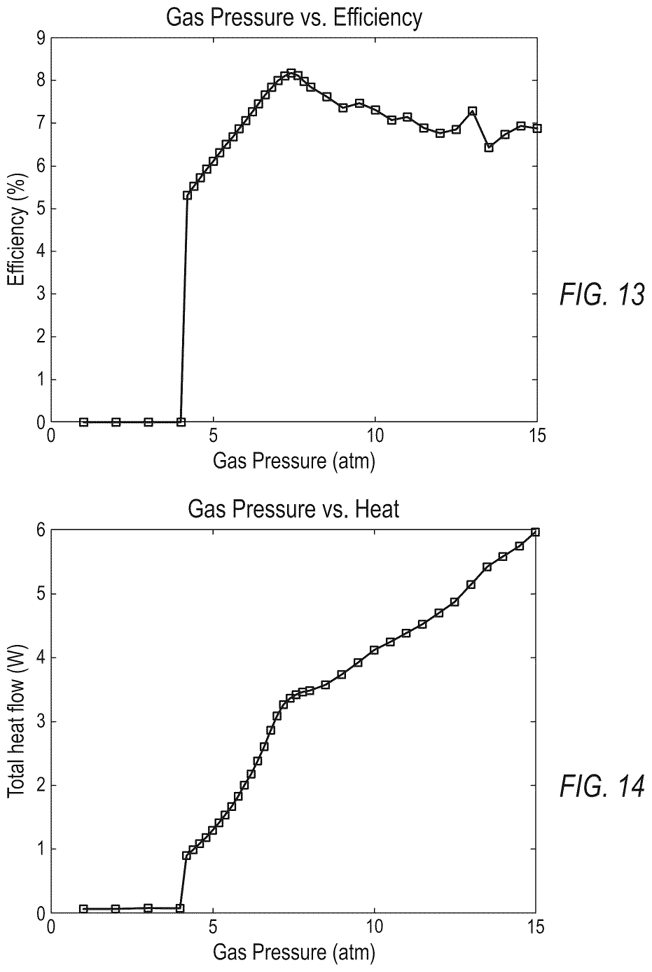

FIG. 13 illustrates a chart of an example gas pressure vs. efficiency. FIG. 14 illustrates a chart of an example gas pressure vs. heat energy.

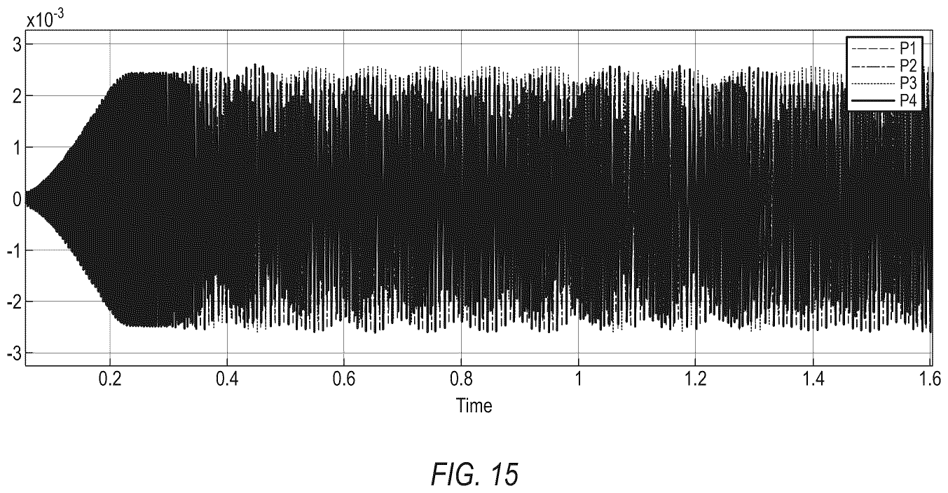

FIG. 15 illustrates a chart of piston motion over time at a gas pressure of greater than or equal to 8.0 atm. After 7.4 atm, while the hot side and cold side are held at constant temperatures, the efficiency starts to decrease, but the heat continues to increase. In some cases, the piston motion may become unstable above a threshold gas pressure, such as above 8 atm.

In addition to the previously reference parameters, slightly increasing the piston mass may result in a higher efficiency, but also creates a slight total heat increase to compensate for the increased mass. In one example, a piston mass of 2.34e⁻⁴ kg is desired.

With respect to the type of gas, helium gas may reach higher efficiencies, and this may correspond to a higher total heat in the system. However, Nitrogen may be an easier gas to contain and can provide efficiencies near 6.5% with reduced total heat.

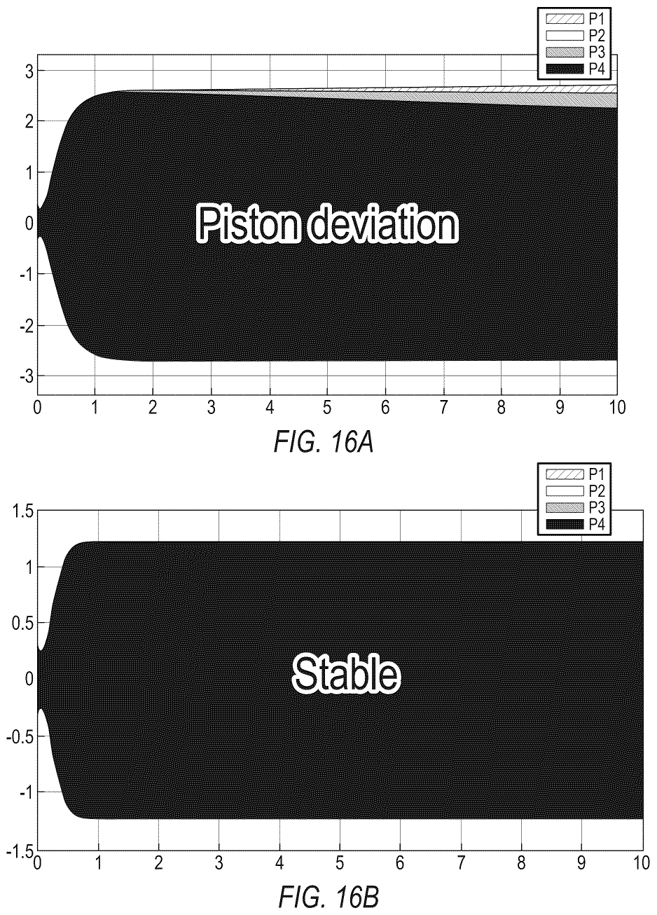

FIGS. 16A and 16B illustrate a chart of piston motion over time and illustrate a comparison of piston deviation and piston stability.

Various manufacturing methods may be implemented. A mechanical model of the MEMS Stirling system may be used to determine its survivability to loads. A baseline design may be a 4-piston system. The MEMS is being modeled as a solid piece of Borosilicate Glass. In this example, the follow characteristics may be recognized:
Modulus of Elasticity: 63 Gpa
Poissons Ratio: 0.2
Shear Modulus: 27 Gpa
Fracture Toughness: 0.770 MPa-m\hat{ }0.5
CTE: 4 μm/m-° C.
Thermal Conductivity: 1.2 W/m-K

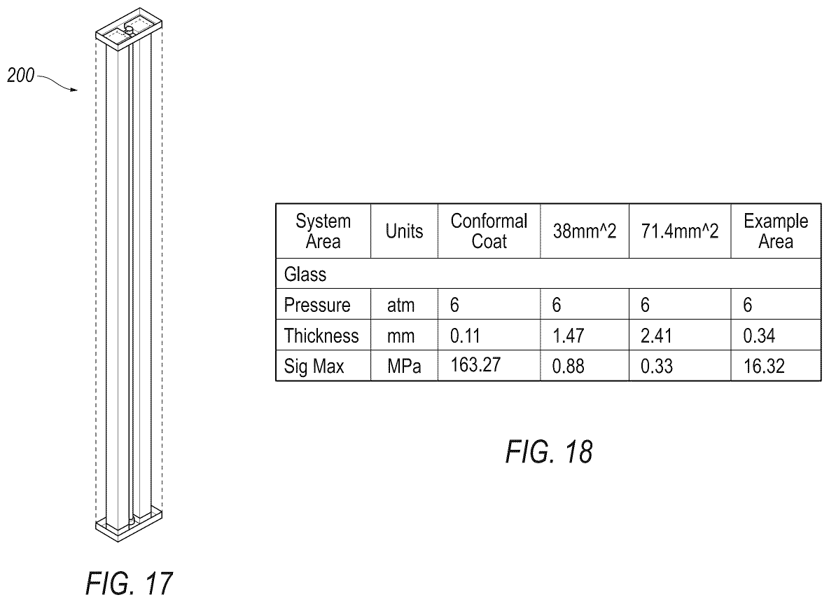

FIG. 17 illustrates an example 2 piston model of a Stirling engine 300. In this example, a model may be created using a 2 piston 302 MEMS Stirling with multiple devices around the circumference of the heat source (integration into solar probes, portable power, microcooling applications, or other waste heat applications). This will allow the engine to take advantage of the geometry of the potential heat source, giving a long piston and greater separation between the hot and cold sides. Further, moving the MEMS Stirling engines to the outside may provide better structural stability.

In selecting housing materials, the desire is to maximize the thermal resistance with sufficient mechanical strength to survive an example load. The charts below illustrate the figure of merit of the yield strength/thermal conductivity.

TABLE 3
Example Material Property Values

| | Yield/Thermal | | Thermal |
|---|---|---|---|
| Material | Conductivity | t | Resistance |
| BoroSilicate | 67.99 | 2.41 | 175 |
| Ti 6Al4V | 131.34 | 0.38 | 276 |
| Grade 5 | | | |
| Alumina 95% | 13.68 | 1.07 | 30 |
| Silicon Carbide | 1.92 | 1.11 | 4 |

TABLE 4
Example Material Property Values

| | Yield | Housing | Safety | Safety | | Natural | Natural | Natural |
|---|---|---|---|---|---|---|---|---|
| | Strength/ | Area | Factor- | Factor- | Thermal | Frequency- | Frequency- | Frequency- |
| Material | (k*E) | [mm\hat{ }²] | Tension | Bending | Resistance | Spring/Mass | Torsion | Bending |
| PEEK30 | 39.95 | 17.97 | 39.79 | 5 | 1943 | 92 | 118526 | 290 |
| BoroFloat | 1.07 | 76.38 | 33.93 | 5 | 164 | 620 | 1104492 | 1153 |
| TI 6Al4V | 1.15 | 8.88 | 40.53 | 5 | 252 | 282 | 464895 | 1204 |
| Grade 5 | | | | | | | | |
| PI | 184.5 | 13.99 | 40.14 | 5 | 6092 | 55 | 78880 | 192 |
| (Unfilled) | | | | | | | | |
| Selenium | 10.35 | 9.97 | 40.46 | 5 | 716 | 95 | 166170 | 385 |

Assuming the example housing size, mechanical properties for glass, specifically an example SCHOTT BORFLOAT glass, are illustrated below. In this case, areas of solid glass with square area are matched and hollow glass, glass area is matched with interior volume of pistons and regenerator is removed.

TABLE 5
Example Engine Parameter Values

| Parameter | Value | Units |
|---|---|---|
| Housing area | 2.204 | mm² |
| Piston length | 14 | mm |
| Regen radius | 0.65 | mm |
| K | 100 | |
| D | 0.0213 | |
| Efficiency | ~7.1% | |
| Power | 2.00 | W |
| Frequency | ~100 | Hz |

Material selection may be based on compression, tension, and bending loads.

FIG. 18 illustrates example values for various glass properties. FIG. 18 depicts how loads exerted on the micro stirling engine can change due to pressurized gas.

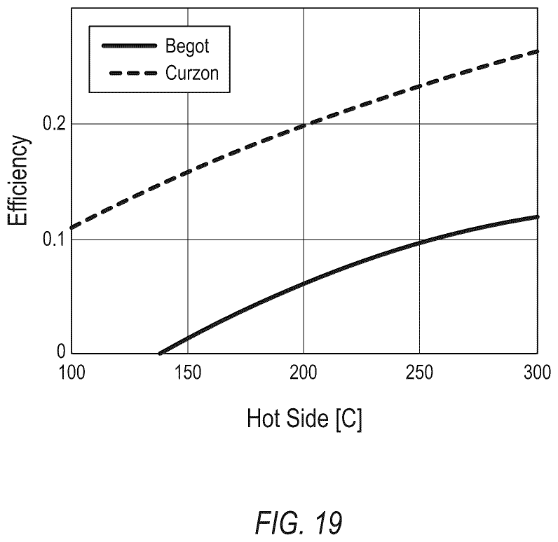

FIG. 19 illustrates an example chart of efficiency vs. hot side temperature, where the cold side is assumed to be 15 C, and the micro Stirling engine disclosed may have an efficiency between the two curves where the Curzon efficiency is

$$1 - \sqrt{\frac{{T}_{c}}{{T}_{h}}} .$$

FIG. 19 can further depict a bounding of a possible lowest efficiency and a possible highest efficiency. Other example parameters may also be used. The chart below lists additional parameters:

TABLE 6
Example Engine Parameter Values

Piston length = 0.8 cm
Cold side temperature = 300 K
Dead volume (above piston) = 0.01682 cm³
Desired oscillating frequency = 100 Hz
Gas Type = Helium
Cap material: Silicon
MatProperties.Silicon.density = 2329; % kg/m\hat{ }3
MatProperties.Silicon.ThermCond = 124; % W/m-K
MatProperties.Silicon.SpecHeatCap = 794; % J/kg-K
MatProperties.Silicon.CTE = 2.49e−6; % m/m-K
Housing material: Glass
MatProperties.Glass.density = 2230; % kg/m\hat{ }3
MatProperties.Glass.ThermCond = 1.2; % W/m-K
MatProperties.Glass.SpecHeatCap = 792; % J/kg-K
MatProperties.Glass.CTE = 3.25e−6; % m/m-K
Regenerator material: Copper
MatProperties.Copper.density = 8930; % kg/m\hat{ }3
MatProperties.Copper.ThermCond = 385; % W/m-K
MatProperties.Copper.SpecHeatCap = 385; % J/kg-K
MatProperties.Copper.CTE = 16.4e−6; % m/m-K

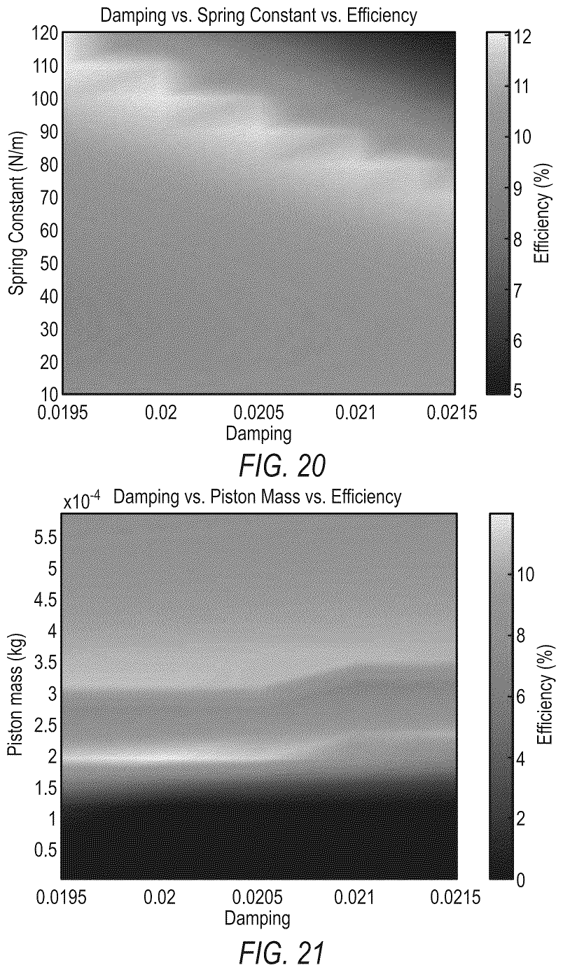

Each of the parameters may have a relationship with other parameters and may affect the overall efficiency. Various relationships between the parameters (e.g, damping, spring constant, efficiency, and piston mass, among others) can be interrelated, defining an interdependence between three or more parameters. Various examples of different parameter interdependencies can be viewed in FIG. 20-23.

FIG. 20 illustrates an example chart of the efficiency based on the damping vs. spring constant. This chart illustrates a multi-variable design having a constant heat flow and a power input of 2 Wth and initial hot side temperature of 500K, with all other parameters being held constant.

FIG. 21 illustrates an example chart of the efficiency based on damping vs. piston mass. This chart illustrates the multi-variable design having a constant heat flow and a power input of 2 Wth and initial hot side temperature of 500K, with all other parameters being held constant.

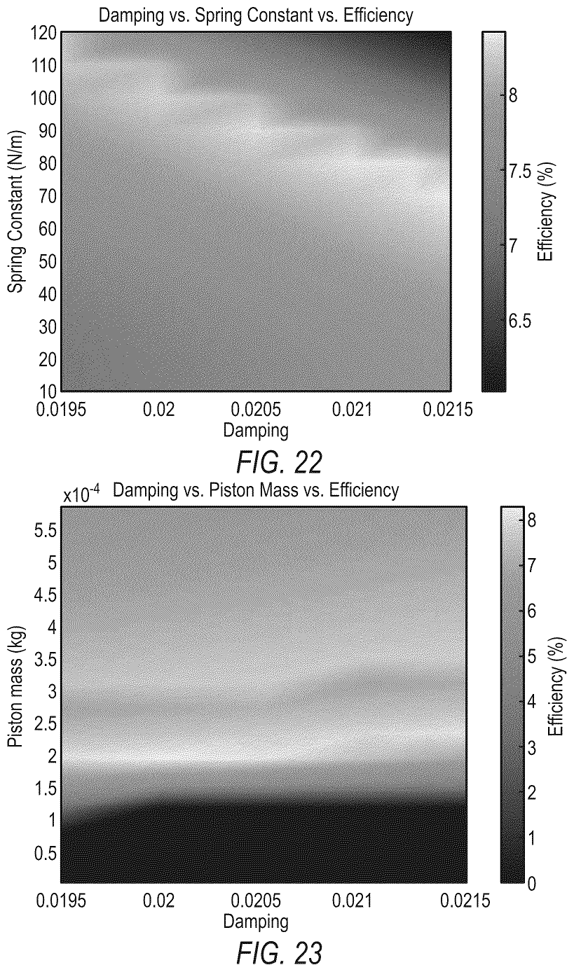

FIG. 22 illustrates an example chart of the efficiency based on the damping vs. spring constant. This chart illustrates a multi-variable design having a constant heat flow and initial hot side temperature of 500K, with all other parameters being held constant. In this example, the hot side and cold side temperatures were held constant with no control over the total heat flow into the system. By holding the other parameters constant, other heat flows could be confirmed, as well as how the varied parameters affected the efficiency. In this example, generally, the efficiency of the engine 200 increases as the spring constant decreases and the damping increases.

FIG. 23 illustrates an example chart of the efficiency based on damping vs. piston mass. This chart illustrates the multi-variable design having a constant temperature differential and initial hot side temperature of 500K, with all other parameters being held constant. In this example, the hot side and cold side temperatures were held constant with no control over the total heat flow into the system. By holding the other parameters constant, other heat flows could be confirmed, as well as how the varied parameters affected the efficiency. In this example, generally, the efficiency of the engine 200 increases as the spring constant decreases and the damping increases.

In all, the engine 200 may use less material, be smaller, have higher reliability and higher efficiencies than existing solutions. For example, the engine 200 may enjoy up to a three times increase in efficiency while having the same heat input.

Additional application of the engine 200 may also be appreciated. For example, waste heat may be recovered, as more energy is lost at low temperature. Low-cost conversion technology that could recover even a small amount of the lost energy would have a tremendous impact. Further, miniaturized cooling systems may be used for high density cooling of microelectronics where the engine 200 could act in an inverse cooling mode.

Computing devices described herein generally include computer-executable instructions, where the instructions may be executable by one or more computing devices such as those listed above. Computer-executable instructions may be compile d or interpreted from computer programs created using a variety of programming languages and/or technologies, including, without limitation, and either alone or in combination, Java™, C, C++, C#, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A heat engine for utilizing temperature differential for high efficiency heat conversion, comprising:
a housing having a hot side and a cold side;
a plurality of pistons arranged within the housing, each extending from the hot side to the cold side and configured to actuate according to working gases heated therewithin by the hot side of the housing; and
a plurality of regenerators, each configured to be arranged between two adjacent pistons and configured to store heat generated as the working gas moves across the pistons.

2. The heat engine of claim 1, wherein at least one material of the housing is selected based on thermal conductivity and a size of the housing.

3. The heat engine of claim 2, wherein at least a portion of the housing is formed of glass.

4. The heat engine of claim 1, wherein the plurality of pistons includes an even number of pistons.

5. The heat engine of claim 4, wherein the pistons are arranged in a two by two arrangement within the housing.

6. The heat engine of claim 4, further comprising a piezo generator for recovering power from the actuation of the pistons.

7. The heat engine of claim 1, wherein the regenerators are arranged within cavities created between the adjacent pistons.

8. The heat engine of claim 1, wherein the pistons are at least one of double acting free pistons, physical hard-stop pistons and spring pistons.

9. The heat engine of claim 1, wherein the pistons actuate in a specific phase enforced by electronic force feedback.

10. The heat engine of claim 1, wherein the pistons are hollow pistons having an internal vacuum.

11. The heat engine of claim 1, further comprising a coupling capacitor for recovering power from the actuation of the pistons.

12. The heat engine of claim 1, further comprising at least one magnet and coil pairing for recovering power from the actuation of the pistons.

13. The heat engine of claim 1, wherein the housing includes at least one end cap formed of silicon and wherein the housing is hermetically sealed.

14. The heat engine of claim 1, wherein the pistons have properties effecting an efficiency of the heat engine, the properties including at least a spring constant and damping.

15. The heat engine of claim 14, wherein the efficiency of the heat engine is increased as the damping increases and the spring constant decreases.

16. The heat engine of claim 1, wherein the pistons have a piston mass between 2-4 kg.

17. A heat engine for utilizing temperature differential for high efficiency heat conversion, comprising:
a housing having a hot side and a cold side;
a plurality of pistons arranged within the housing, each extending from the hot side to the cold side and configured to actuate according to working gases heated therewithin by the hot side of the housing; and
at least one regenerator arranged between two adjacent pistons and configured to store heat generated as the working gas moves across the pistons.

18. The heat engine of claim 17, wherein the housing is hermetically sealed to maintain a gas therein, the housing formed of a material to maintain stable operating temperatures.

19. The heat engine of claim 17, wherein the housing is formed at least in part of at least one of glass and silicon.

20. The heat engine of claim 17, wherein the housing is formed of glass and sealed with a silicon cap.
